(19) United States
(12) Patent Application Publication
(10) Pub. No.: US 2026/0127421 A1
(43) Pub. Date: May 7, 2026

(54) QUANTIZATION FOR NEURAL NETWORK

(71) Applicant: TEXAS INSTRUMENTS INCORPORATED, DALLAS, TX (US)

(72) Inventors: Arthur REDFERN, DALLAS, TX (US); John ROBERTSON, AUSTIN, TX (US)

(21) Appl. No.: 19/375,734

(22) Filed: Oct. 31, 2025

Related U.S. Application Data
(60) Provisional application No. 63/715,687, filed on Nov. 4, 2024.

(51) Int. Cl. G06N 3/0495

(52) U.S. Cl. CPC G06N 3/0495

(57) ABSTRACT

A described example relates to a processor-implemented method that includes receiving a set of input data to a neural network. The method also includes selecting, from multiple sets of quantization scales for the neural network, a set of quantization scales for the neural network and the set of input data. Each set of the multiple sets of quantization scales is stored in memory and is associated with a respective input data cluster of multiple input data clusters. The method also includes performing an inferencing operation on the set of input data using the neural network with the selected set of quantization scales.

### CROSS-REFERENCE TO RELATED APPLICATION

This application claims the benefit of and priority to U.S. provisional patent application No. 63/715,687, filed on Nov. 4, 2024, and entitled “Quantization for Neural Network,” which is incorporated herein by reference in its entirety.

### TECHNICAL FIELD

This disclosure relates to machine learning models, such as neural networks, and, more specifically, to conditional quantization for neural networks or other machine learning models.

### BACKGROUND

Neural networks are directed acyclic graphs. Data flows on edges between nodes which perform various operations. Floating-point computations and fixed-point computations may be employed when implementing a neural network. Converting between a higher precision floating point operation and lower precision fixed point operation via an affine transformation and rounding operation is a process known as quantization. Quantization can allow the layers of the neural network to perform fixed point computations, which can be converted (or dequantized) back to floating-point data at the output of the neural network. Existing methods of quantization, such as static or dynamic quantization, may result in accuracy loss and/or higher computational costs.

### SUMMARY

One example relates to a processor-implemented method that includes receiving a set of input data to a neural network. The method also includes selecting, from multiple sets of quantization scales for the neural network, a set of quantization scales for the neural network and the set of input data. Each set of the multiple sets of quantization scales is stored in memory and is associated with a respective input data cluster of multiple input data clusters. The method also includes performing an inferencing operation on the set of input data using the neural network with the selected set of quantization scales.

Another example relates to an integrated circuit that includes one or more processors and memory. The memory can store data and instructions, in which the data includes multiple sets of quantization scales, and parameters of a neural network. The instructions, when executed by the one or more processors, cause the one or more processors to provide a set of input data to an input layer of the neural network and select, from the multiple sets of quantization scales, a set of quantization scales for the neural network and the set of input data, based on an analysis of the set of input data. The instructions can further cause the one or more processors to perform an inferencing operation on the set of input data using the neural network, the inferencing operation including quantization based on the selected set of quantization scales.

Yet another example relates to a processor-implemented method that includes providing multiple sets of input data to a neural network. The method also includes determining, for each set of input data of the multiple sets of input data, a respective set of quantization scales for layers of the neural network. The method also includes clustering the multiple sets of input data into multiple data clusters based on the respective sets of quantization scales for the multiple sets of input data. The method also includes determining, for each data cluster of the multiple data clusters, a respective set of cluster quantization scales that includes quantization scales for the layers of the neural network. The respective set of cluster quantization scales for each data cluster of the multiple data clusters can be stored in memory for use during inferencing.

### BRIEF DESCRIPTION OF THE DRAWINGS

FIG. 1 is a block diagram of an example of a neural network system that includes conditional quantization.

FIG. 2 is a block diagram of another example of a neural network system that includes conditional quantization.

FIG. 3 is a block diagram of an example of a semiconductor device that can implement a neural network that includes conditional quantization.

FIG. 4 is a flow diagram illustrating an example of a method for processing a set of input data using a neural network that includes conditional quantization.

FIG. 5 is a flow diagram illustrating an example of a method to determine sets of quantization scales and train a cluster predictor for a neural network.

FIG. 6 is a graph illustrating part of an example neural network.

FIGS. 7-11 are tables demonstrating examples of data at various stages of the method of FIG. 5.

FIG. 12 is a flow diagram illustrating an example of a method for determining quantization scales for layers of a neural network.

FIG. 13 is a flow diagram illustrating an example of a clustering method that can be used for determining quantization scales for conditional quantization in a neural network.

FIG. 14 is a diagram illustrating an example of determining conditional quantization scales at a layer of a neural network that may be performed in the method of FIG. 13.

FIG. 15 is a table illustrating an example of clustering performed according to the method of FIG. 13.

FIG. 16 is a table illustrating another example of clustering where a new cluster has been added to the table of FIG. 15 according to the method of FIG. 13.

FIG. 17 is a table illustrating an example of precision improvement using conditional quantization techniques disclosed herein.

### DETAILED DESCRIPTION

This disclosure relates to neural networks and other machine learning models, and, more specifically, to systems and methods of conditional quantization for neural networks and other machine learning models.

An artificial neural network (also referred to herein as a neural network or, simply, a network) can be used to model and reproduce nonlinear processes for a variety of applications. The network can include a plurality of processing nodes arranged in multiple layers, in which nodes of one layer are connected to nodes of one or more other layers. The network can also include weights, scale factors (also referred to as quantization scales), and other parameters, which are applied to connections between nodes and node inputs for computations at the respective nodes.

As described above, existing methods of quantization, such as static quantization where the quantization scales may be the same for all inputs or dynamic quantization where the quantization scales may be dynamically changed for each input, may result in accuracy loss and/or higher computational costs. According to some examples disclosed herein, a neural network can perform conditional quantization, in which the network may select, based on a set of input data provided to the network, a set of quantization scales from multiple sets of predetermined quantization scales to process the set of input data. For example, each set of quantization scales can be stored in memory associated with a respective data cluster of multiple data clusters. The set of input data (or a portion thereof) that is provided to the neural network can be analyzed (e.g., by a portion of the network or a separate network) to identify or predict to which of the multiple data clusters the set of input data belongs. For example, the data cluster can be identified based on one or more features or properties of the set of input data. A scale selector of the network can select the set of quantization scales based on the identified (or predicted) data cluster. For example, the selected quantization scales (scale factors) can be loaded to respective layers of the neural network, such that a quantization scale is applied to the outputs (e.g., activations) of each node in a given layer to produce quantized outputs that are sent as inputs to the next layer. The neural network can perform an inferencing operation on the set of input data based on the selected set of quantization scales and provide a corresponding output (e.g., a quantized output). The resulting output provided by the output layer of the network can be dequantized. The particular inferencing operation of the neural network can be trained according to application requirements. Some example applications include image processing (e.g., classification, object detection, image based semantic segmentation, depth and motion processing, etc.), audio processing (e.g., audio tracking, etc.), as well as other operations (e.g., generative artificial intelligence, data security, medical diagnosis, etc.). As a result of including the conditional quantization disclosed herein in the neural network, the neural network can exhibit improved accuracy and precision in a resource-constrained environment compared to other quantization methods.

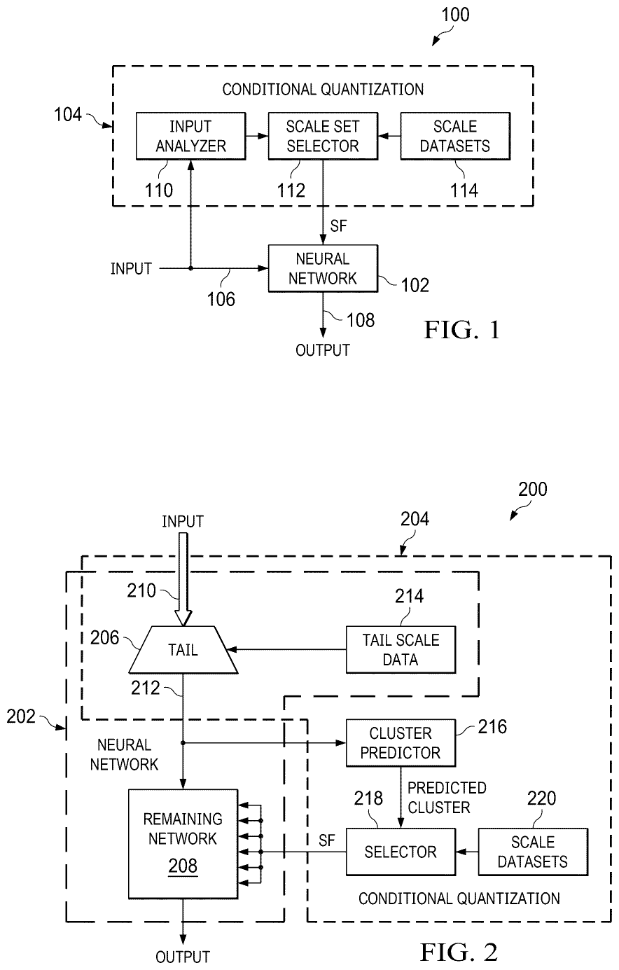

FIG. 1 is a block diagram of an example of a trained neural network system 100 that may perform conditional quantization. As described herein, the neural network system 100 can be trained (e.g., using TensorFlow or PyTorch) for deployment within memory and computational constraints of an embedded processing circuit or other resource-constrained circuits. For example, the neural network system 100 can be implemented as instructions and data (e.g., weights, scaling factors, and other network parameters) executable by one or more processors and/or accelerators in a system on chip (SOC) or system in package (SIP) that includes the embedded processing circuit.

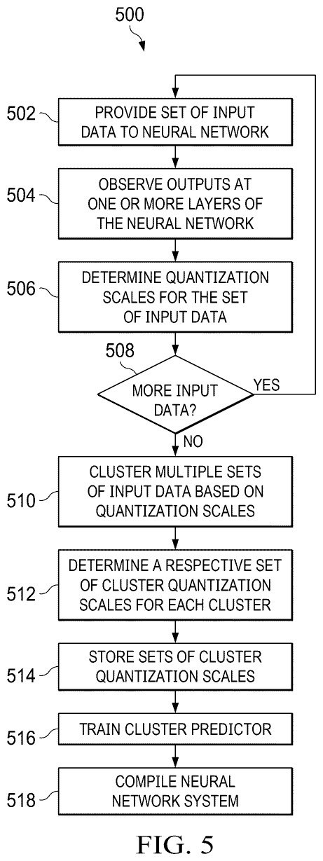

In the example of FIG. 1, the neural network system 100 includes a neural network 102 and a conditional quantization function 104. The neural network 102 includes an input 106 and an output 108. The conditional quantization function 104 is configured to select a set of quantization scales (e.g., scale factors (SF)) for the neural network 102 based on a set of input data (INPUT) provided to the input 106 of the neural network. There can be a discrete number of sets of quantization scales determined during a training procedure, as described herein (see, e.g., FIGS. 5-14).

As an example, the conditional quantization function 104 includes an input analyzer 110, a scale set selector 112 (also referred to as a selector), and multiple cluster scale datasets 114 (also referred to as multiple sets of cluster quantization scales, multiple sets of quantization scales, or multiple scale factor vectors) for multiple data clusters. The input analyzer 110 receives a set of input data (INPUT), which is also provided to the input 106 of the neural network 102. The input analyzer 110 can determine one or more features of at least a portion of the set of input data (INPUT). The input analyzer can further identify one of the multiple data clusters for the set of input data based on the one or more features. For example, the input analyzer 110 is configured to classify the set of input data into one of the multiple data clusters. Quantization scales for the multiple data clusters can be stored in memory (e.g., system memory or local memory such as cache of an embedded processing circuit) as respective cluster scale datasets 114. For example, each cluster scale dataset includes an associated set of quantization scales, which can be determined using sets of training data as part of a training process for the neural network 102 and/or input analyzer 110, such as described herein (see, e.g., FIGS. 5-14). The scale set selector 112 can be configured to select a set of quantization scales (e.g., a scale factor vector) from the cluster scale datasets 114 based on the cluster identified (or predicted) by the input analyzer 110. The selected set of quantization scales (SF) are provided to the neural network 102. The neural network 102 is configured to perform an inferencing operation based on the set of input data (INPUT) and the selected set of quantization scales SF to provide corresponding output data (OUTPUT) at the output 108. For example, the inferencing operation performed by the neural network 102 includes output data quantization, in which a respective scale factor from the selected set of quantization scales SF is applied to the outputs of each node in a given layer of the neural network to produce quantized outputs that are sent as inputs to the next layer.

In a first example, the input analyzer 110 is implemented as a classifier that is separate from the neural network 102. The classifier can be implemented as a neural network, decision tree, random forest, support vector machine, or another machine learning model that is trained to predict which of the multiple data clusters the set of input data INPUT belongs to. The scale set selector 112 can be configured to select a set of quantization scales from the cluster scale datasets 114 based on the classification of the set of input data INPUT and provide the selected set of quantization scales SF to the neural network 102. The neural network 102 may then perform an inferencing operation based on the set of input data INPUT and the selected set of quantization scales SF to produce the OUTPUT at the output 108.

In a second example, the input analyzer 110 is implemented as an integral part of the neural network 102, such as an input tail portion (e.g., one or more layers from the input layer) of the network. The output data from the tail portion of the neural network, defining the input analyzer 110, can be provided to a remaining portion of the network and to a cluster predictor (e.g., a classifier trained based on the output data from the input tail portion). The cluster predictor (e.g., at least part of the input analyzer 110) can predict which cluster the set of input data belongs to and the scale set selector 112 can select the set of quantization scales SF responsive to the predicted cluster identified by the cluster predictor. In the second example, the selected set of quantization scales SF can be loaded to the remaining layers of the trained neural network. The neural network 102 can perform an inferencing operation based on the intermediate output produced by the tail portion and the selected set of quantization scales SF to provide the OUTPUT at the output 108.

FIG. 2 is a block diagram of another example of a neural network system 200 that may perform conditional quantization. The neural network system 200 includes a neural network 202 and a conditional quantization system 204. The neural network system 200 is an example of the neural network system 100 of FIG. 1. Accordingly, the description of FIG. 2 may refer to certain aspects of FIG. 1.

The neural network 202 includes a first network portion, shown as a tail 206, and a second network portion, shown as a remaining network 208. For example, the tail 206 includes one or more layers at an input of the neural network 202, in which each of the one or more layers includes an arrangement of nodes having outputs connected to inputs of nodes of a next layer, either within the tail 206 or the remaining network 208. The tail 206 includes an input 210, which is the input of the neural network 202, and is configured to receive a set of input data (INPUT) at the input 210. The tail 206 is configured to provide a tail output at an intermediate network output (or tail output 212) responsive to the set of input data INPUT and tail scale data 214. Other parameters (e.g., weights and/or biases) can also be applied to connections between nodes and node inputs of the tail 206 for computing respective outputs at the respective nodes of the tail portion. The tail 206 can provide tail output data at the tail output 212, defining intermediate results of one or more layers of the tail 206, to a next network layer in the remaining network 208. A copy of tail output can also be provided as an input to another functional block of the conditional quantization system 204. While, in the example shown in FIG. 2, the conditional quantization system 204 includes the tail of the neural network 202, in other examples, the tail 206 of the neural network 202 may be implemented (e.g., as code) independent from the conditional quantization system 204, with a copy of the tail output being provided as an input to the conditional quantization system 204.

In an example, the tail scale data 214 includes a static (e.g., predetermined) set of one or more quantization scales (or scale factors) that have been determined for the tail 206 and are loaded to the one or more respective layers of the tail 206 for quantizing outputs of the one or more respective layers. The tail 206 is configured to perform an input operation on at least a portion of the set of input data INPUT and including quantization based on the set of static quantization scales. For instance, the set of static quantization scales for the tail can be generated to provide the tail with quantization scale data because the range of scales over different inputs tends to be relatively uniform for the tail 206. Such uniformity in the range of scales for the tail 206 can be observed over different networks and different inputs, and may occur because the types of features generated by the tail 206 are relatively uniform (e.g., not spiky) for different networks and inputs, and/or a smaller number of feature maps can result in reduced range swings in the inner products across the feature maps. In other examples, the tail scale data 214 can be determined dynamically (e.g., on the fly) for the tail 206 based on the set of input data INPUT.

The conditional quantization system 204 may implement conditional quantization by applying a selected set of quantization scales to the remaining network 208 based on the tail output determined by the tail 206, as described herein. In the example of FIG. 2, the conditional quantization system 204 includes a cluster predictor 216, a selector 218, and multiple quantization scale datasets (also referred to as multiple sets of quantization scales) 220. For example, the cluster predictor 216 can be a classifier (e.g., a neural network) trained to determine a probability (or other measure of similarity) that the set of input data INPUT belongs to a particular set of cluster data based on the tail output provided at 212. For the example where the set of input data INPUT represents an input image, the classifier can be programmed as a neural network or other machine learning model to perform classification based on the tail output determined by the tail 206. Alternatively, the classifier may compute one or more feature maps for the set of input data INPUT based on the tail output determined by the tail 206. The one or more feature maps, being based on early layers of the neural network 202, can represent features like edges, shapes, and corners, which may be used to compute, for example, a measure of similarity (e.g., a distance, cosine similarity, probabilistic measure or likelihood, etc.) for predicting which cluster dataset the set of input data INPUT belongs to. As described herein, multiple cluster scale datasets, each having a respective set of quantization scales, can be determined for a set of training input data as part of a training process for the neural network 202 and/or cluster predictor 216 as described herein (see, e.g., FIGS. 5-14). The selector 218 can select and load a set of the quantization scales (e.g., a scale factor vector) from the quantization scale datasets 220 based on the cluster dataset that has been identified by the cluster predictor. The selected set of quantization scales (SF) are loaded to the remaining network 208, which is configured to perform an inferencing operation based on the tail output and the selected set of quantization scales SF to provide corresponding output data (OUTPUT). In some examples, a respective quantization scale in the selected set of quantization scales may be loaded when each layer of the remaining network 208 is executed. The inferencing operation performed by the remaining network 208 can include output data quantization, in which a respective scale factor from the selected set of quantization scales SF is applied to the outputs (e.g., activations) of nodes in a given layer of the neural network to produce quantized outputs that are sent as inputs to the next layer. Other parameters (e.g., weights and/or biases) can also be applied to connections between nodes and node inputs of the remaining network 208 for computing respective outputs at the respective nodes.

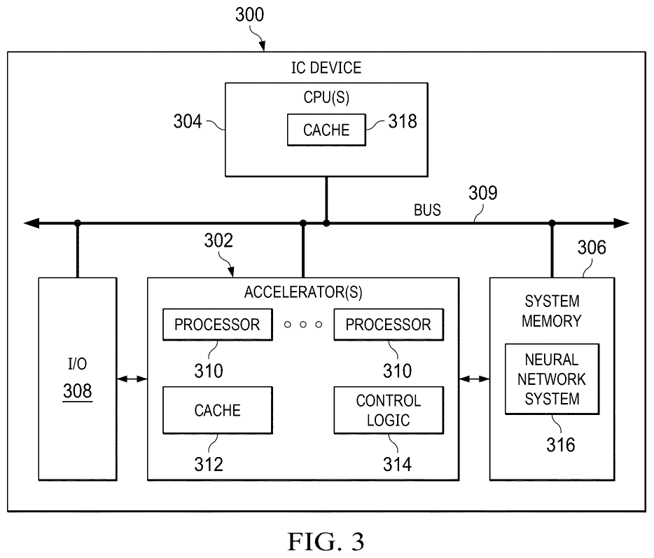

FIG. 3 is a block diagram of an example of an integrated circuit (IC) device 300 (e.g., a semiconductor device) that is used to implement a neural network that includes conditional quantization. For example, the IC device 300 can be an SOC device including embedded processor(s), such as an ARM processor based on the reduced instruction set computing (RISC) architecture or a RISC-V processor. In the example of FIG. 3, the IC device 300 includes one or more accelerators 302, one or more central processing units (CPUs) 304, system memory 306, and an input/output (I/O) system 308, each of which can be coupled to an internal bus 309 (e.g., an interconnect) of the IC device.

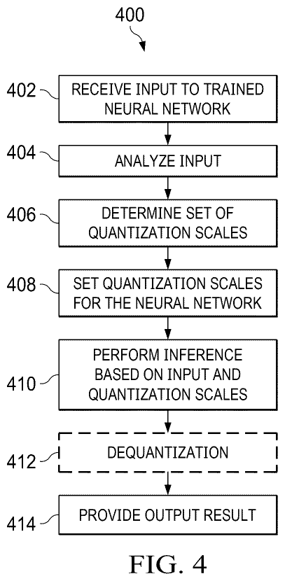

The system memory 306 (e.g., one or more non-transitory storage media, such as Static Random Access Memory (SRAM), Dynamic Random Access Memory (DRAM), and/or various forms of Read-Only Memory (ROM)) can include data and instructions configured to implement a neural network system 316 that, when executed by the CPU 304 and/or accelerator 302, cause the CPU and/or accelerator to perform functions described herein. For example, the trained neural network system 316 includes a neural network and a conditional quantization system, such as implemented according to the example systems of FIGS. 1 and 2, and/or the method of FIG. 4.

As an example, the neural network system 316 (e.g., implemented by CPU 304 and/or accelerator 302) can receive a set of input data. In an example, the set of input data includes an image or frames of video, an audio file, or another type of data to be processed by the neural network system 316. The set of input data can be provided to the CPU through the I/O system 308 and stored in the system memory 306 for processing according to the trained neural network and conditional quantization systems. In some examples, the set of input data (or a portion thereof) can be stored in cache 312 of the accelerator 302 and/or in cache 318 of the CPU 304. In an example, the caches 312 and 318 define a shared cache memory structure (e.g., L2 or L3 cache) that allows both the accelerator 302 and the CPU 304 to access the same data without needing to copy the data to facilitate implementing the neural network system 316. The accelerator 302 can be coupled to the system memory 306 through the internal bus 309. Additionally, or alternatively, the accelerator 302 can be coupled to the system memory 306 directly to enable direct memory access of data and/or instructions in the system memory, such as the neural network system and/or data that is propagated through and/or computed by respective layers of the neural network.

In the example of FIG. 3, the accelerator 302 can also include one or more processors 310, the cache 312, and control logic 314. The one or more processors 310 of the accelerator 302 can be implemented as, for example, digital signal processors (DSPs), graphic processing units (GPUs), tensor processing units (TPUs), network processing units (NPUs), and additional hardware to accelerate computations such as for machine learning, image processing, and signal processing. In an example, the one or more processors 310 (e.g., DSPs) includes hardware configured to perform matrix multiply-accumulate (MMA) operations that include matrix multiplication followed by an accumulation operation. The MMA can compute the product of two matrices and add the result to an accumulator, such as for performing operations in layers of the neural network. As described above, the accelerator(s) 302 and/or the CPU(s) 304 may also perform other operations of the neural network, such as data/weight quantization/dequantization, activation, and pooling. The control logic is configured to control the flow of data and instructions between the accelerator and the CPU 304 for executing operations for the neural network system 316 based on the set of input data.

As a further example, the neural network system 316 can include a cluster predictor network (e.g., input analyzer 110 or cluster predictor 216) configured to classify a set of input data into a data cluster based on the set of input data, so that a set of the quantization scales may be selected (e.g., by selector 112, 218) for the trained neural network system 316 based on the data cluster and multiple cluster datasets. As described herein, the cluster predictor network can be part of the trained neural network (e.g., one or more layers from the input layer) or another trained model configured to predict which data cluster of multiple data clusters the set of input data belongs to. For example, the cluster predictor network can be a separate neural network that is specifically trained to classify each set of input data into one of the multiple data clusters. The selected set of quantization scales can be loaded to the neural network for performing respective quantization (e.g., by applying respective scale factors) on the outputs of each layer of the neural network. The CPU 304 and/or accelerator 302 can further execute instructions to perform an inferencing operation on the set of input data using the neural network with quantization that is performed based on quantization scales loaded for each layer of the neural network.

FIG. 4 is a flow diagram depicting an example method 400 for processing a set of input data using a neural network that includes conditional quantization. The method 400 can be executed by one or more processors (e.g., digital signal processors, accelerators, CPUs, and/or other types of processors) of an IC, an SOC, and SIP, or another computing device based on a set of instructions (e.g., software and/or firmware) that have been compiled for the processor(s) and stored in memory. While, for purposes of simplicity of explanation, the example method 400 is shown and described as executing serially, it is to be understood and appreciated that the example method is not limited by the illustrated order. The method 400 can be implemented by the neural network system 100 neural network system 200, and/or IC device 300.

The method 400 includes, at 402, receiving a set of input data at an input of a neural network (e.g., network 102, 202, or neural network system 316). The set of input data can include an image data, audio data, or another type of data (e.g., data from another type of sensor) that the neural network is trained to process and provide prediction results.

At 404, the set of input data is analyzed (e.g., by input analyzer 110 or by tail 206 and cluster predictor 216), such as to determine which of multiple input data clusters the set of input data belongs to. Each of the input data clusters has an associated set of quantization scales. In a first example, the analysis can include extracting one or more features of the set of input data and classifying the set of input data into a respective data cluster based on at least a portion of the one or more features. In a second example, the classification can be implemented by another neural network that has been trained to predict which data cluster a given set of input data belongs to more than any other of the input data clusters (e.g., based on a probability or likelihood). In a third example, the analysis can include executing operations by a tail portion of the neural network (e.g., tail 206) based on the set of input data and providing intermediate data outputs. The intermediate data outputs can be provided to inputs of a remaining portion of the neural network and to a cluster predictor (e.g., cluster predictor 216). The cluster predictor (e.g., a neural network or other machine learning model) can be trained to predict, for example, based on the intermediate data outputs, which data cluster the set of input data belongs to.

At 406, the operation of method 400 includes determining a set of quantization scales for the neural network and the set of input data based on the analysis at 404 (e.g., based on which data cluster the set of input data is determined to belong to and/or has been classified into). Each set of the multiple sets of quantization scales (e.g., scale datasets 114, 220) can be stored in memory and may be associated with a respective one of the multiple input data clusters. At 408, the selected set of quantization scales can be loaded from the memory to respective layers of the neural network. In examples where the analysis at 404 is implemented apart from the neural network (e.g., by an independent analyzer), the quantization scales can be loaded at each layer of the neural network. In other examples, where the analysis at 404 is implemented by a portion of the neural network (e.g., by a tail portion of the network), the quantization scales can be loaded for the remaining layers of the neural network, excluding the tail portion utilized to perform the analysis, and a predetermined set of one or more quantization scales can be loaded for the tail portion.

At 410, the method includes performing an inferencing operation on the set of input data using the neural network with the selected set of quantization scales. The inferencing operation can include respective mathematical operations executed by nodes at each layer of the neural network and based on quantization scales that are applied to the respective outputs of each layer of the network. In some examples, at 412, the method can include performing dequantization on outputs produced by the neural network. The dequantization can be implemented on the outputs provided by an output layer of the neural network. Additionally, or alternatively, dequantization can be implemented on the outputs of one or more other layers (e.g., hidden layers) of the neural network. At 414, an output result can be provided. The output result can depend on the particular task that the neural network is designed to perform, such as to indicate a prediction, probability, and/or confidence for the task, and have a form (e.g., value or set of values) consistent with that task.

FIG. 5 is a flow diagram depicting an example of a method 500 to determine multiple sets of quantization scales and train a cluster predictor for a neural network. The method can be implemented as instructions stored in a one or more non-transitory machine readable media that, when executed by one or more processors, cause the one or more processors to perform the method 500. In some examples, the method can be implemented in a computing system, such as a GPU-based workstation or a cloud-based infrastructure having sufficient computing resources for training based on large training data sets.

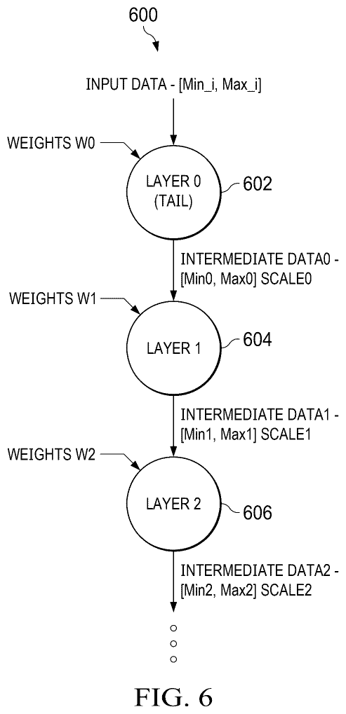

The method 500 of FIG. 5 will also be described with respect to FIGS. 6-11 for additional context. FIG. 6 is a graph depicting part of an example neural network 600, which can be used in the method 500 and as otherwise described herein. FIGS. 7-11 depict tables demonstrating examples of data at various stages of the method 500 as the data is being processed.

In FIG. 6, the neural network 600 includes a number of layers 602, 604, and 606, shown as Layer 0, Layer 1, Layer 2, respectively. In the example of FIG. 6, the layer 602 defines a tail (input layer) that receives a set of input data. In other examples, the tail can include more than one layer at the beginning of the network 600. Each of the layers 602, 604, and 606 can include a number of nodes (or neurons) configured to perform respective mathematical operations (e.g., weighted summation and activation). The neural network parameters can include weights, which can be stored as a weight matrix. The weight matrix can include a respective vector of weights for each of the layers 602, 604, and 606, shown as WEIGHTS W0, WEIGHTS W1, and WEIGHTS W2, respectively. Each of the layers 602, 604, and 606 is configured to provide a respective output, shown as INTERMEDIATE DATA0, INTERMEDIATE DATA1, or INTERMEDIATE DATA2, to a next layer of the network or at an output if the layer is an output layer of the network. Each of layers 602, 604, and 606 can also include a respective quantization scale (shown as SCALE0, SCALE1, or SCALE2) that can be applied to the activations at each layer for appropriate quantization, such as conversion from a floating point format (e.g., 32-bit floating point FLOAT32) to a quantized integer format (e.g., 8-bit signed integer INT8, 8-bit unsigned integer UINT8, 16-bit signed integer INT16, 16-bit unsigned integer UINT16, etc.). The range of INTERMEDIATE DATA0, INTERMEDIATE DATA1, or INTERMEDIATE DATA2 for each layer thus can vary (e.g., within a range between minimum and maximum values), depending on the set of input data received thereby (e.g., at the input or from a preceding layer), the respective weights, a quantization scale that is applied, and other parameters (e.g., biases). The results generated by the output layer of the neural network can be, for example, a classification label or a numeric value.

Referring back to FIG. 5, the method 500 begins at 502, in which a set of input data is provided to a neural network (e.g., network 600) as part of a training process for the neural network. For example, the set of input data that is provided at 502 can be one sample of multiple samples of training data for training the neural network for a particular task, and be received by the tail of the network (e.g., layer 602).

At 504, the method 500 includes observing outputs of each of one or more network layers of the neural network based on the set of input data provided at 502. For example, FIG. 7 depicts a table 700 for a neural network (e.g., network 600), where each row of a plurality of rows represents outputs (e.g., an output vector) that is computed at each layer (shown in columns of table 700) of the neural network for a respective set of input training data. As an example, a first set of input training data (TRAINING DATA 0) results in outputs OUTPUT0,i, where “i” is an integer ranging from 0 through “N” identifying a respective layer of the network. Each set of input training data, ranging from set 0 through set “M” (where M is an integer defining the number of training data sets) can result in a respective set of outputs for each of the N+1 layers. The output at each layer can be a vector having one or more output values depending on the number of nodes implemented at the respective layer of the network 600.

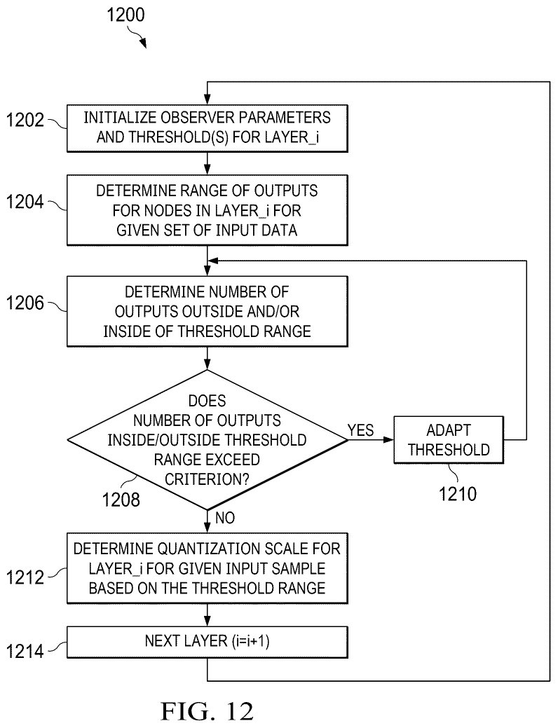

In some examples, such as shown in the method of FIG. 12, the observing of outputs at 504 can include determining a threshold range of the outputs of the given layer for the set of input data based on, for example, a number or percentage of outputs in the outputs of the given layer for the set of input data that are outside and/or inside of the threshold range. As described in detail below with respect to FIG. 12, the threshold range can be adjusted in an iterative process based on an evaluation of the number or percentage of outputs in the outputs of the given layer for the set of input data that are outside and/or inside of the threshold range, until the number or percentage of outputs in the outputs of the given layer for the set of input data that are outside and/or inside of the threshold range meets a criterion (e.g., another threshold).

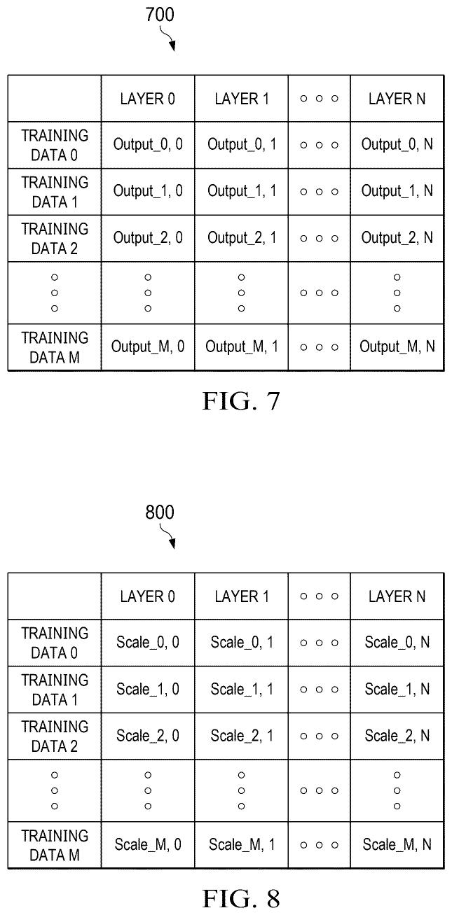

At 506, a respective set of quantization scales is determined for the one or more layers of the neural network based on the outputs observed (at 504) for the set of input data. For example, FIG. 8 depicts a table 800 for a neural network (e.g., network 600) having quantization scales determined for the one or more layers of the neural network for a respective set of input training data. As an example, a first row of the table 800 includes a set of quantization scales, shown as SCALE_0,i (e.g., i ranging from 0 through N), for respective layers of the neural network based on a set input training data (TRAINING DATA 0). The quantization scale determined for each layer can be a scalar value or a vector, and the set of quantization scales for the one or more layers can be a vector. Each set of input training data ranging from set 0 through set “M” can have quantization scales determined (at 506) in a similar manner based on the observed outputs (e.g., as shown in table 700) for each layer of the network, such as shown in the table 800.

The quantization scales can be determined at 506 according to any of a variety of methods. In one example, a volume-based observer can be implemented to determine a quantization scale for each layer and each set of input data (see, e.g., FIG. 12). In another example, Min-Max scaling is implemented to determine the quantization scale for each layer and each set of input data, in which the scale for each layer is computed based on the minimum and maximum values of the outputs of the layer. In yet another example, mean and/or standard deviation of the outputs of each layer can be used to normalize the output values at each layer, and the quantization scale for each layer and each set of input data can be determined based on the distribution of the outputs. Other methods can be used to determine the quantization scales for respective layers of the network at 506 in other examples. The quantization scale for each layer can be used to map the outputs of the layer to a target quantized integer format (e.g., INT8, UINT8, INT16, INT32, UINT16, UINT32, etc.) based on, for example, the threshold range determined using the volume-based observer, or the range of outputs (e.g., minimum and maximum values) computed by respective nodes of the given layer. The target quantized format can be a default format or can be programmable in response to a user input.

At 508, a determination is made as to whether there are any more sets of input data for the method 500. If the determination at 508 is positive (YES), indicating that more data sets are available for training, the method returns to 502 and the actions at 502, 504, and 506 are repeated for each set of input data. Thus, at 504 respective outputs (e.g., output vectors) can be determined for each layer based on each subsequent iteration of the neural network with the next set of input data (TRAINING DATA 1 through TRAINING DATA M), such as to provide the table 700 of outputs. At 506, a respective quantization scale can be determined for each layer (layers 0 through N) based on the output vector determined at 504 for each respective set of input data, such as shown in the table 800 of FIG. 8. If the determination at 508 is negative (no), indicating there are no more data sets for training, the method can proceed to 510.

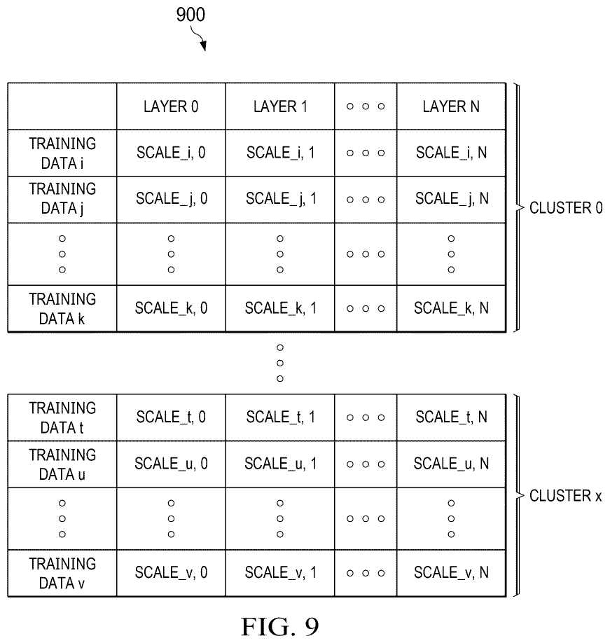

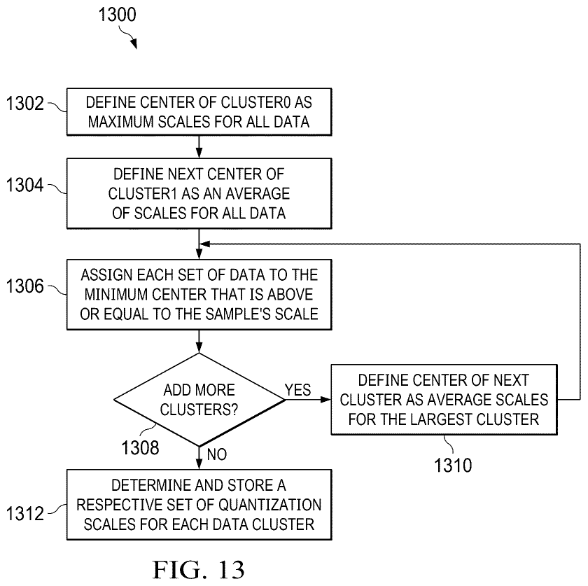

At 510, the method includes clustering the multiple sets of input data into multiple data clusters based on the respective sets of quantization scales for the multiple sets of input data. For example, FIG. 9 depicts multiple data clusters 900, in which sets of the input data and associated quantization scales are arranged in multiple data clusters, shown as CLUSTER 0 through CLUSTER X, where X is a positive integer representing the number of clusters. There can be any number of two or more data clusters (e.g., X≥2). The number of clusters can be user-defined and/or be determined based on the clustering algorithm. In an example, the clustering at 510 provides no more than a predetermined number data clusters (e.g., two, three, four, five, six, seven, or more data clusters). In FIG. 9, CLUSTER 0 includes multiple sets of input data, shown as TRAINING DATA i through TRAINING DATA k, each associated with a respective set of quantization scales. CLUSTER X includes multiple sets of input data, shown as TRAINING DATA t through TRAINING DATA v, each associated with a respective set of quantization scales. More details of clustering the multiple sets of input data into multiple data clusters based on the respective sets of quantization scales for the multiple sets of input data are described below with respect to, for example, FIGS. 13-16.

In one example, the clustering at 510 can include determining, for the layers of the neural network, maximum and mean scale values of the respective sets of quantization scales for the multiple sets of input data. Each set of input data of the multiple sets of input data can be assigned to a corresponding data cluster of the multiple data clusters based on the maximum and mean scale values that are determined. In other examples, one or more other clustering methods can be used for clustering the sets of input data based on the sets of quantization scales determined for the respective layers (e.g., k-means clustering, hierarchical clustering, Gaussian mixture models, and/or combinations thereof).

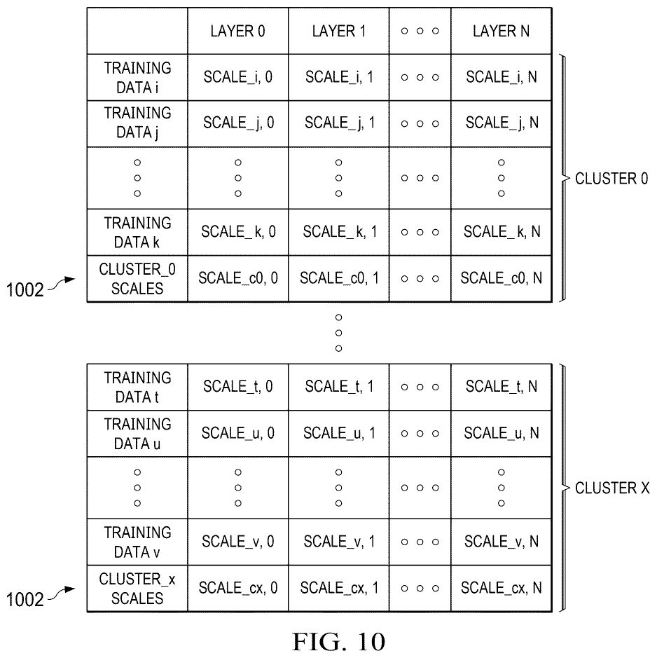

At 512, the method includes determining, for each data cluster determined at 510 and based on respective sets of quantization scales for each data cluster, a respective set of cluster quantization scales for each of the data clusters. Each set of quantization scales includes a quantization scale determined for each of the layers of the neural network. For example, as shown in FIG. 10, a set of cluster quantization scales 1002 are determined for each data cluster, shown as CLUSTER_0 SCALES through CLUSTER_X SCALES. As an example, the set of cluster quantization scales 1002 for CLUSTER_0 includes a quantization scale determined for each of the N+1 layers (e.g., SCALE_C0,0 through SCALE_C0,N). The cluster quantization scale can be determined for a given layer of the neural network based on the quantization scales determined for the given layer for each set of input data, such as by computing a maximum of the scales for each given layer of the respective cluster. As an example, SCALE_C0,0 can be computed for CLUSTER 0 by computing the maximum value of scales for layer 0 (e.g., the maximum of SCALE_i,0, SCALE_j,0, . . . and SCALE_k,0). In another example, the quantization scale for each layer and each data cluster can be determined based on a threshold quantization scale (e.g., the center of the quantization scale for a cluster) used to cluster sets of input data into the respective data cluster, as described below with respect to, for example, FIGS. 13-16. Other statistical or mathematical methods can be used to determine a quantization scale for each of the layers of each respective data cluster, which can depend on the size of the respective clusters and/or range of scale values for the respective layer.

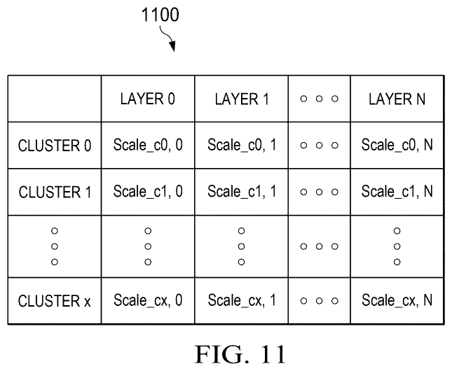

At 514, the method 500 includes storing the respective set of cluster quantization scales (determined at 512) for each data cluster. For example, FIG. 11 depicts a table 1100 demonstrating sets of quantization scales determined for a number of data clusters, shown as CLUSTER 0 through CLUSTER X, each of which includes a respective set of quantization scales for the N+1 layers of the neural network. A respective set of cluster quantization scales can be selected for processing a given set of input data through the neural network, as described herein with respect to, for example, FIGS. 1-4.

At 516, the method can further include training a cluster predictor based on, for example, the sets of quantization scales and/or other features of the sets of input data in each data cluster. For example, the cluster predictor (e.g., a neural network or other machine learning model) can be trained to classify sets of input data into one of the clusters represented by the stored cluster data (e.g., predicting which one of CLUSTER 0 through CLUSTER X in FIG. 11 a set of input data belongs to based on a set of features). A set of parameters (e.g., weights, biases, quantization scales, etc.) executable instructions can be stored in memory to implement the model trained for generating a prediction for a set of input data. As examples, the input data for training the cluster predictor can be the set of input data that is received by the neural network (e.g., corresponding to the input analyzer 110 of FIG. 1) or intermediate outputs of the neural network (e.g., outputs from tail 206 of FIG. 2).

At 518, a corresponding neural network system can be compiled for a given processing environment, such as to provide an executable set of instructions and data that, when executed by one or more processors/accelerators of the given processing environment, cause the processor(s) and/or accelerator(s) to execute a method, as described herein (e.g., to implement the neural network system 100, 200, 316 and/or method 400). The given processing environment can be a general-purpose computer or a resource-constrained computing apparatus, such as a semiconductor device that includes an SOC (e.g., IC device 300) or another type of computing apparatus. In an example, the neural network system compiled at 518 includes a neural network and an integrated conditional quantization system, which are compiled together to provide the neural network system (e.g., the neural network system 100, 200, 316). In another example, the conditional quantization system can be compiled separately from the neural network to provide separate compiled modules that may be linked for runtime and/or may be executed sequentially or in parallel in the processing environment.

FIG. 12 is a flow diagram depicting an example method 1200 for determining quantization scales for layers of a neural network. The method 1200 begins at 1202, in which observer parameters, such as one or more thresholds and criteria, are initialized to starting values for a given layer i of the neural network (where i is a positive integer denoting the number of layers of the network for which quantization scales are being determined).

At 1204, a range of outputs for nodes in the given layer (layer i) for a given set of input data is determined. The range of outputs can indicate minimum and maximum values for the outputs (e.g., activations) computed at the given layer. At 1206, the number or percentage of outputs having values outside and/or inside of one or more thresholds is determined. The one or more thresholds can define a range of output values that is smaller than the full range of outputs determined at 1204.

At 1208, a determination is made as to whether the number or percentage of outputs outside and/or inside of the threshold range exceeds a criterion. The criterion can be a default value or be user programmable to establish a volume of acceptable outliers at the given layer. The criterion can define a fraction (or percentage) of outputs that are outside the threshold range with respect to outputs inside the threshold range. If the determination at 1208 is positive (YES) indicating that the number or percentage of outputs outside of the threshold range exceeds the criterion, the method proceeds to 1210 to adapt the threshold up or down by a step size to, for example, increase the threshold range so that, potentially, more outputs will fall within the established threshold range. The method proceeds from 1210 to 1206 to determine the number or percentage of outputs having values outside and/or inside of the adapted threshold range. The method can loop at 1206, 1208, and 1210 to iteratively adapt the threshold range until the threshold range converges to a value where the established criterion is satisfied at 1208 indicating that a desired fraction of outputs are outside and/or inside the threshold range. Responsive to a negative determination at 1208 (NO), indicating that the number or percentage of outputs outside and/or inside of the threshold range does not exceed (e.g., the number satisfies) the criterion, the method proceeds to 1212.

At 1212, the method includes determining a quantization scale for the given layer (layer i) based on a set of the outputs determined (at 1206) to reside within the threshold range that satisfies the criterion at 1208. In an example, the quantization scale for the given layer can be determined based on the threshold range for outputs values that is set at 1210 to a value where the observed outputs satisfy the criterion. In this way, an acceptable number of outliers can be omitted from generating the quantization scale that is determined for the given layer of the neural network to increase accuracy for the neural network.

At 1214, the method proceeds to process the next layer i (where i=i+1) of the neural network. From 1214, the method returns to 1202 to repeat the method 1200 based on the outputs observed at each next layer of the neural network. Each resultant set of quantization scales for the layers of the neural network can be stored in memory for the respective set of input data, such as shown in the table of FIG. 8. The method 1200 can thus be implemented for a given set of input data to determine a respective quantization scale for each respective layer of the network. By allowing a certain quantity of outliers, the method 1200 can reduce potential quantization noise and improve precision compared to, for example, setting quantization scales using Min-Max scaling.

FIG. 13 is a flow diagram depicting an example method 1300 for clustering input data and determining quantization scales for conditional quantization in a neural network, as described herein. At 1302, the method 1300 includes defining a center of a first cluster (CLUSTER0) as the maximum quantization scale at each layer of the network for all sets of observed input data. In one example, the cluster quantization scale for the first cluster (CLUSTER0) at each layer of the network may be the maximum quantization scale at each layer for all sets of observed input data. At 1304, a center of a next cluster (CLUSTER1) is defined as the average quantization scale at each layer of the network for all sets of observed input data. In one example, the cluster quantization scale for the second cluster (CLUSTER1) at each layer of the network may be the average quantization scale at each layer for all sets of observed input data. Other criteria can be used to define the scales at each respective layer for clusters at 1302 and 1304. At 1306, each set of input data is assigned to the minimum center of the data cluster (CLUSTER0 or CLUSTER1) that is above or equal to the scale of the set of input data at each layer for all observed layers in the neural network.

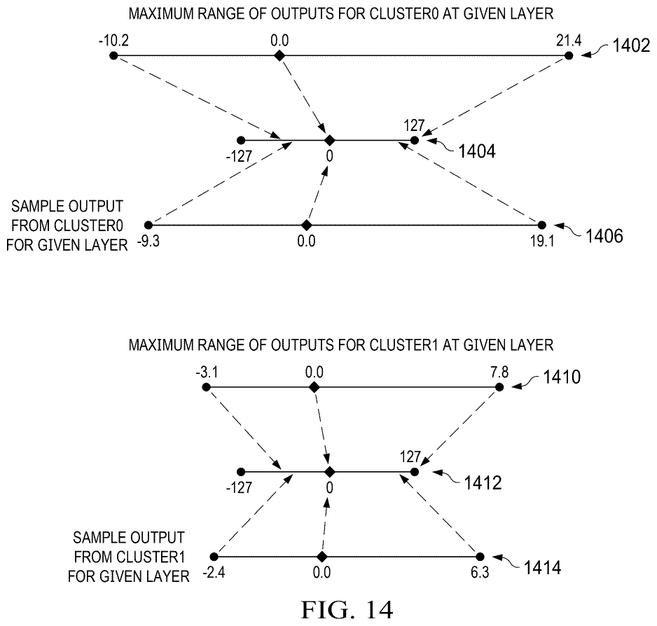

At 1308, a determination is made as to whether to add any more clusters. For example, the determination at 1308 can be based on the relative size of the existing clusters. Additionally, or alternatively, the determination at 1308 can be based on a distance between the set of quantization scales of a given set of input data from the center of its currently assigned cluster. If the determination is positive (YES), indicating that another cluster is to be added, the method proceeds to 1310. At 1310, the method includes defining a center of the next cluster (CLUSTER2) as the average scale for the largest cluster (CLUSTER0 or CLUSTER1) at each layer. The method proceeds from 1310 to 1306 in which each set of input data is assigned to the minimum center of the cluster (CLUSTER0, CLUSTER1, or CLUSTER2) that is above or equal to the scale of the set of input data at each layer for all observed layers in the neural network. At 1308, the method determines whether any additional clusters are to be added. In response to a negative determination (NO) at 1308, indicating that no additional clusters are to be added, the method proceeds to 1312 and a respective set of cluster quantization scales are determined and stored in memory for each data cluster, such as to provide cluster quantization scales at the layers of the neural network for the sets of input data in each data cluster (see, e.g., FIG. 11). The respective set of cluster quantization scales at layers of the network for each data cluster can be determined as described above with respect to, for example, 512 of FIG. 5 and FIG. 10 above and FIGS. 14-16 below

FIG. 14 depicts examples of ranges of output values at a given layer for two data clusters (CLUSTER0 and CLUSTER1), and examples of conditional quantization of the output values at the given layer for two sets of input data belonging to the two data clusters. A range of output values, shown at 1402, at the given layer for sets of input data in CLUSTER0 goes from −10.2 to 21.4 in floating-point format. The maximum value (e.g., 21.4) of the output values shown at 1402 can be mapped from its floating-point format to a maximum integer value, shown at 1404 (e.g., 127 in INT8 format), by applying a corresponding scale factor (e.g., SF 0=127/21.4) for CLUSTER 0. Other output values in the range of output values shown at 1402 for CLUSTER 0 may be mapped to integer values (e.g., in INT8 format) using the same scale factor SF0 for CLUSTER0. FIG. 14 also depicts output values 1406 (e.g., ranging from −9.3 to 19.1) at the given layer for a set of input data that belongs to CLUSTER0. The range of the output values 1406 fits within the range of output values for CLUSTER 0 shown at 1402, and the output values 1406 may be mapped into integer values (e.g., in INT8 format) by applying the scale factor SF0 for CLUSTER0 to the output values 1406.

FIG. 14 also depicts that a range of output values, shown at 1410, at the given layer for sets of input data in CLUSTER 1 goes from −3.1 to 7.8 in floating-point format. The maximum value (e.g., 7.8) of the output values shown at 1410 can be mapped from its floating-point format to a maximum integer value show at 1412 (e.g., 127 in INT8 format), by applying a corresponding scale factor (e.g., SF1=127/7.8) for CLUSTER1. Other output values in the range of output values shown at 1410 for CLUSTER 1 may be mapped to integer values (e.g., in INT8 format) using the same scale factor SF1 for CLUSTER1. FIG. 14 also depicts output values 1414 (e.g., ranging from −2.4 to 6.3) at the given layer for a set of input data that belongs to CLUSTER 1. The range of the output values 1414 fits within the range of output values for CLUSTER 1 shown at 1410, and the output values 1414 may be mapped into integer values (e.g., in INT8 format) by applying the scale factor SF1 for CLUSTER1 to the output values 1414.

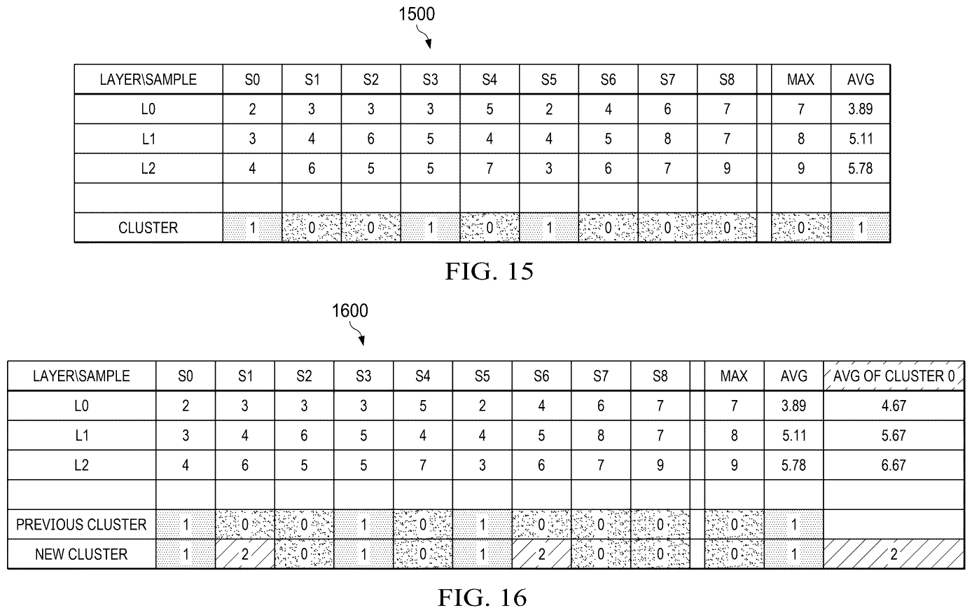

As a further example, FIGS. 15 and 16 depict simplified examples of clustering that can be performed according to the method of FIG. 13. The simplified examples can be expanded to a neural network having any number of layers and based on any number of input samples (also referred to herein as sets of input data). FIG. 15 depicts an example of a table 1500 that includes sets of quantization scales for three layers of a neural network (shown as layers L0, L1, and L2) based on input samples (shown as samples S0 through S8) of input data provided to the network and the initial clustering of the samples of input data based on the sets of quantization scales. The values of the quantization scales for respective layers of the network can be determined based on any of the approaches described herein (see, e.g., FIGS. 5-8 and 12). In the example of FIG. 15, the table 1500 shows two initial clusters (e.g., cluster 0 and cluster 1). For example, as described above with respect to FIG. 13, cluster 0 can be defined at 1302 based on the maximum quantization scale for all input samples in each of the layers L0, L1, and L2. In the example of FIG. 15, the maximum quantization scale for layer L0 is 7, the maximum quantization scale for layer L1 is 8, and the maximum quantization scale for layer L2 is 9. Similarly, cluster 1 can be defined at 1304 as the average (or mean) of quantization scales for all input samples in each of the layers L0, L1, and L2. Therefore, the center (and the cluster quantization scales) of cluster 0 may be represented by a vector {7, 8, 9} for layers L0, L1, and L2. In the example of FIG. 15, the average of quantization scales for layer L0 is 3.89, the average of quantization scales for layer L1 is 5.11, and the average of quantization scales for layer L2 is 5.78. Therefore, the center (and the cluster quantization scales) of cluster 1 may be represented by a vector {3.89, 5.11, 5.78} for layers L0, L1, and L2. The samples S0 through S8 are clustered (e.g., at 1306) by assigning each input sample to a cluster having the minimum center that is above or equal to the quantization scale of the sample at each layer. Thus, samples S1, S2, S4, S6, S7 and S8 are initially clustered into cluster 0 because, for each of these input samples, at least one quantization scale at one network layer is above the corresponding quantization scale of the center of cluster 1, whereas samples S1, S4, and S6 are initially clustered into cluster 1 because their quantization scales at all three layers are lower than the corresponding quantization scales of the center of cluster 1.

FIG. 16 depicts another example table 1600 in which a new cluster has been added to the table 1500 according to the example method 1300. As shown in FIG. 16, responsive to determining at 1308 to add a new cluster, shown as cluster 2, a center of cluster 2 at each layer can be defined as an average of the quantization scales in each of the layers L0, L1, and L2 a for all input samples in the largest cluster (e.g., cluster 0 in the illustrated example). In the example of FIG. 16, the average of the quantization scales in layer L0 for all input samples in previous cluster 0 is 4.67, the average of the quantization scales in layer L1 for all input sample in previous cluster 0 5.67, and the average of the quantization scales in L2 for all input sample in previous cluster 0 is 6.67. Each of the input samples is then assigned to one of the three clusters by assigning each input sample to a cluster having a minimum center that is above or equal to the quantization scale of the input sample at each layer. In FIG. 16, samples S1 and S6 are thus assigned to cluster 2 because their quantization scales at all three layers are lower than the corresponding quantization scales of the center of cluster 2, while samples S2, S4, S7, and S8 are assigned to (e.g., remain in) cluster 0 because, for each of these four input samples, at least one quantization scale at one network layer is above the corresponding quantization scale of the center of cluster 2. Similarly, samples S0, S3, and S5 can remain in cluster 1 because their quantization scales at all three layers are lower than the corresponding quantization scales of the center of cluster 1.

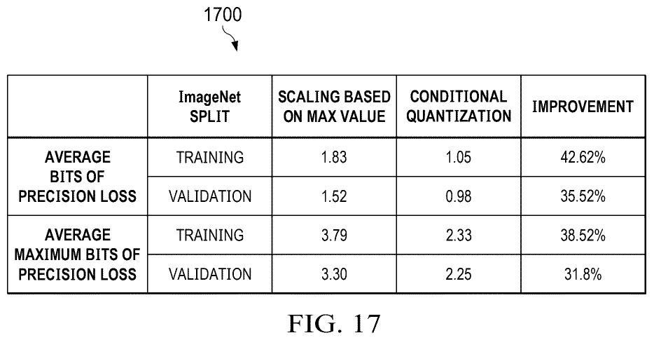

FIG. 17 is a table 1700 illustrating an example of precision improvement using the conditional quantization techniques disclosed herein. Table 1700 shows the average bits of precision lost using maximum value scaling (where a static maximum scale factor may be used in each layer for all input samples) and conditional scaling techniques disclosed herein for a set of training samples and a set of validation samples from samples in ImageNet. In Table 1700, one bit of precision loss corresponds to a loss of a half of the range of available quantized values (e.g., from 256 possible values to 128 possible values when the precision is reduced from 8-bit to 7-bit). As shown in Table 1700, the average bits of precision loss can be significantly reduced (e.g., by over 35%) for both the training samples and the validation samples using the conditional quantization techniques disclosed herein, compared with the static maximum value scaling. Table 1700 also shows the average maximum bits of precision lost using maximum value scaling and the conditional scaling techniques disclosed herein for a set of training samples and a set of validation samples from samples in ImageNet. As shown in Table 1700, the average maximum bits of precision loss can be significantly reduced (e.g., by over 30%) for both the training samples and the validation samples using the conditional quantization techniques disclosed herein, compared with the static maximum value scaling.

It should be understood that various aspects described herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this description are described as being performed by a single module or unit for purposes of clarity, it should be understood that the techniques of this description may be performed by a combination of units or modules.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a processor). For example, instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure(s) or any other physical structure suitable for implementation of the described techniques. Also, the techniques could be fully implemented in one or more circuits or logic elements.

In this description, numerical designations “first,” “second,” etc. are not necessarily consistent with same designations in the claims herein and these numerical designations are used to simply distinguish one element from another. Also, the term “based on” means based at least in part on.

Additionally, the term “couple” or variants thereof may cover connections, communications, or signal paths that enable a functional relationship consistent with this description. For example, if device A generates a signal to control device B to perform an action, then: (a) in a first example, device A is directly coupled to device B; or (b) in a second example, device A is indirectly coupled to device B through intervening component C if intervening component C does not alter the functional relationship between device A and device B, so device B is controlled by device A via the control signal generated by device A.

In this description, the term “based on” means based at least in part on. Also, as used herein, the term “includes” means includes but not limited to, and the term “including” means including but not limited to.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter. Modifications are possible in the described embodiments and other embodiments are possible within the scope of the claims.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Where the description or claims recite “a,” “an,” “a first,” or “another” element, or the equivalent thereof, it should be interpreted to include one or more than one such element, neither requiring nor excluding two or more such elements.

Furthermore, a circuit or device that is said to include certain components may instead be configured to couple to those components to form the described circuitry, device, or system. For example, a structure described as including one or more elements A, B and C may instead include only the A elements within a single physical device and may be configured to couple to at least some of the elements B and/or C to form the described circuitry, device, or system, either at a time of manufacture or after a time of manufacture, for example, by an end-user and/or a third-party.

All references, publications, and patents cited in the present application are herein incorporated by reference in their entirety.

What is claimed is:

1. A processor-implemented method comprising:
receiving a set of input data to a neural network;
selecting, from multiple sets of quantization scales for the neural network, a set of quantization scales for the neural network and the set of input data, wherein each set of the multiple sets of quantization scales is stored in memory and is associated with a respective input data cluster of multiple input data clusters; and
performing an inferencing operation on the set of input data using the neural network with the selected set of quantization scales.

2. The processor-implemented method of claim 1, wherein selecting the set of quantization scales for the neural network comprises:
extracting, from the set of input data, one or more features of the set of input data; and
classifying the set of input data into a first input data cluster of the multiple input data clusters based on at least a portion of the one or more features of the set of input data, wherein the selected set of quantization scales is stored in the memory for the first input data cluster.

3. The processor-implemented method of claim 2, wherein the neural network is a first neural network, and classifying the set of input data comprises:
predicting, by a second neural network, that the set of input data belongs to the first input data cluster of the multiple input data clusters more than any other input data clusters of the multiple input data clusters, wherein the second neural network is trained to predict which of the multiple input data clusters a respective set of input data is associated with.

4. The processor-implemented method of claim 2, wherein the neural network includes a first network portion and a second network portion, the first network portion comprises one or more layers at an input of the neural network, the second network portion comprises a remaining portion of the neural network, and extracting the one or more features of the set of input data comprises:
performing a first operation on the set of input data using the first network portion to generate an intermediate set of data that indicates the one or more features of the set of input data, wherein the first input data cluster of the multiple input data clusters is selected based on the intermediate set of data.

5. The processor-implemented method of claim 4, wherein performing the inferencing operation comprises performing a second operation on the intermediate set of data using the second network portion with the selected set of quantization scales for layers of the second network portion.

6. The processor-implemented method of claim 4, further comprising loading a predetermined set of one or more quantization scales for the one or more layers of the first network portion, wherein the first operation is performed on the set of input data using the first network portion with quantization based on the predetermined set of one or more quantization scales.

7. The processor-implemented method of claim 1, further comprising loading the selected set of quantization scales from the memory to layers of the neural network before performing the inferencing operation.

8. The processor-implemented method of claim 1, wherein the multiple sets of quantization scales include a respective set of quantization scales that has been determined for each input data cluster of the multiple input data clusters based on results of processing multiple sets of training data using the neural network.

9. The processor-implemented method of claim 1, wherein performing the inferencing operation on the set of input data comprises quantizing an output data set of a respective layer of the neural network from floating-point values to integer values having a reduced number of bits based on at least one quantization scale of the selected set of quantization scales for the respective layer of the neural network.

10. The processor-implemented method of claim 9, wherein the quantization of the output data set of the respective layer comprises an asymmetric quantization or a symmetric quantization.

11. The processor-implemented method of claim 1, wherein the neural network comprises a set of instructions compiled for one or more processors and/or accelerators and stored in a non-transitory storage medium, wherein the set of instructions, when executed by the one or more processors and/or accelerators, cause the one or more processors and/or accelerators to perform the method of claim 1.

12. An integrated circuit, comprising:
one or more processors; and
memory storing data and instructions, wherein the data comprises multiple sets of quantization scales, and parameters of a neural network, and wherein the instructions, when executed by the one or more processors, cause the one or more processors to:
provide a set of input data to an input layer of the neural network;
select, from the multiple sets of quantization scales, a set of quantization scales for the neural network and the set of input data, based on an analysis of the set of input data; and
perform an inferencing operation on the set of input data using the neural network, the inferencing operation including quantization based on the selected set of quantization scales.

13. The integrated circuit of claim 12, wherein the instructions further cause the one or more processors to:
extract, from the set of input data, one or more features of the set of input data; and
classify the set of input data into a first input data cluster of multiple input data clusters based on at least a portion of the one or more features of the set of input data, wherein each of the multiple sets of quantization scales is associated with a respective one of the multiple input data clusters.

14. The integrated circuit of claim 13, wherein the neural network includes a first network portion and a second network portion, the first network portion comprises one or more layers, including the input layer, at an input of the neural network, and the second network portion comprises a remaining portion of the neural network, wherein the instructions further cause the one or more processors to:
perform a first operation on the set of input data using the first network portion to generate an intermediate set of data that indicates or includes the one or more features of the set of input data, wherein the set of input data is classified into the first input data cluster based on the intermediate set of data; and
load the selected set of quantization scales from the memory to respective layers of the second network portion.

15. The integrated circuit of claim 14, wherein the instructions to perform the inferencing operation comprise instructions to perform operations on the intermediate set of input data using the second network portion with the selected set of quantization scales that are loaded to the respective layers of the second network portion.

16. The integrated circuit of claim 15, wherein the instructions further cause the one or more processors to:
load a predetermined set of one or more quantization scales to the one or more layers of the first network portion, wherein the first operation is performed on the set of input data using the first network portion with quantization based on the predetermined set of one or more quantization scales.

17. The integrated circuit of claim 13, wherein the multiple sets of quantization scales include a respective set of quantization scales that has been determined for each input data cluster of the multiple input data clusters based on results of processing multiple sets of training data using the neural network.

18. The integrated circuit of claim 12, wherein the one or more processors include an accelerator, and the neural network comprises a set of instructions compiled for the accelerator and stored in the memory.

19. The integrated circuit of claim 12, wherein the instructions further cause the one or more processors to:
quantize an output data set of a respective layer of the neural network from floating-point values to integer values having a reduced number of bits based on a quantization scale of the selected set of quantization scales for the respective layer of the neural network.

20. The integrated circuit of claim 19, wherein the quantization of the output data set of the respective layer comprises an asymmetric quantization or a symmetric quantization.

21. A processor-implemented method, comprising:
providing multiple sets of input data to a neural network;
determining, for each set of input data of the multiple sets of input data, a respective set of quantization scales for layers of the neural network;
clustering the multiple sets of input data into multiple data clusters based on the respective sets of quantization scales for the multiple sets of input data;
determining, for each data cluster of the multiple data clusters, a respective set of cluster quantization scales that includes quantization scales for the layers of the neural network; and
storing the respective set of cluster quantization scales for each data cluster of the multiple data clusters.

22. The processor-implemented method of claim 21, wherein clustering the multiple sets of input data comprises:
determining, for each layer of the layers of the neural network, a respective maximum value of quantization scales for the layer and the multiple sets of input data, the respective maximum values of the quantization scales for the layers of the neural network and the multiple sets of input data forming a first vector;
determining, for each layer of the layers of the neural network, a respective average value of the quantization scales for the layer and the multiple sets of input data, the respective average values of the quantization scales for the layers of the neural network and the multiple sets of input data forming a second vector; and
clustering the multiple sets of input data using the first vector and the second vector as clustering thresholds.

23. The processor-implemented method of claim 22, wherein clustering the multiple sets of input data using the first vector and the second vector as the clustering thresholds comprises:
assigning a first set of input data of the multiple sets of input data having at least one quantization scale for a layer of the layers of the neural network greater than the respective average value of the quantization scales for the layer to a first data cluster of the multiple data clusters; and
assigning a second set of input data of the multiple sets of input data having no quantization scale for any layer of the layers of the neural network greater than the respective average value of the quantization scales for the layer to a second data cluster of the multiple data cluster.

24. The processor-implemented method of claim 23, wherein clustering the multiple sets of input data further comprises:
selecting a larger data cluster of the first data cluster and the second data cluster;
determining, for each layer of the layers of the neural network, a respective average value of quantization scales for the layer and sets of input data in the larger data cluster, the respective average values of the quantization scales for the layers of the neural network and the sets of input data in the larger data cluster forming a third vector; and
clustering the multiple sets of input data using the third vector as an additional clustering threshold.

25. The processor-implemented method of claim 21, wherein the neural network includes a plurality of layers, and the method further comprises:
observing outputs of each layer of the plurality of layers for each set of input data of the multiple sets of input data,
wherein the respective set of quantization scales for the layers of the neural network is determined for each set of input data of the multiple sets of input data based on the observed outputs for the set of input data of the multiple sets of input data.

26. The processor-implemented method of claim 25, wherein observing the outputs of a given layer of the neural network for each set of input data of the multiple sets of input data comprises:
determining a threshold range of the outputs of the given layer for the set of input data based on a number of outputs in the outputs of the given layer for the set of input data that are outside or inside of the threshold range,
wherein a quantization scale for the given layer of the neural network and the set of input data is determined based on the threshold range.

27. The processor-implemented method of claim 26, wherein determining the threshold range includes adjusting the threshold range based on an evaluation of the number of outputs in the outputs of the given layer for the set of input data that are outside or inside of the threshold range, until the number of outputs in the outputs of the given layer for the set of input data that are outside or inside of the threshold range meets a criterion.

28. The processor-implemented method of claim 21, further comprising:
training a machine learning model to predict which data cluster of the multiple data clusters a given set of input data belongs to, based on one or more features of the given set of input data.
